(19) United States
(12) Patent Application Publication
(10) Pub. No.: US 2006/0136224 A1
(43) Pub. Date: Jun. 22, 2006

(54) Communications devices including positional circuits and methods of operating the same

(76) Inventors: William Chris Eaton, Cary, NC (US); Yojak Vasa, Cary, NC (US); Martin Trively, Roswell, GA (US)

Correspondence Address: MYERS BIGEL SIBLEY & SAJOVEC, P.A., P.O. BOX 37428, RALEIGH, NC, 27627, US

(21) Appl. No.: 11/020,400

(22) Filed: Dec. 22, 2004

(51) Int. Cl. G10L 11/00

(52) U.S. Cl. 704/277

(57) ABSTRACT

Methods of processing signals received at wireless communications devices are provided. First and second audio signals are received from first and second sources, respectively, at the communications device. The first audio signal is assigned to a first speaker channel and the second audio signal is assigned to a different second speaker channel. Thus, sounds emanating from the communications device responsive to the first and second audio signals are perceivably dimensionally separate from one another. Related wireless communications devices are also provided.

### FIELD OF THE INVENTION

The present invention relates to communications devices and, more particularly, to audio circuits of communications devices and methods of operating the same.

### BACKGROUND OF THE INVENTION

Recently, there has been a proliferation of features in the field of wireless communications. Wireless communications devices, such as cordless and cellular telephones, pagers, wireless modems, wireless email devices, personal digital assistants (PDAs) with communication functions, and other wireless communications devices are becoming more commonplace. Some of these wireless communications devices are configured to receive conference calls, i.e., able to connect more than two individuals at geographically distinct locations for simultaneous conversation. However, the voices of the individuals at the remote locations are typically heard through a single speaker at the receiving wireless communications device. Thus, if two or more of the individuals at the remote locations speak simultaneously, distinguishing who the speakers are and what the speakers are saying may be difficult.

### SUMMARY OF THE INVENTION

Some embodiments of the present invention provide methods of processing signals received at a communications device. First and second audio signals are received from first and second sources, respectively, at the communications device. The first audio signal is assigned to a first speaker channel and the second audio signal is assigned to a different second speaker channel. Thus, sounds emanating from the communications device responsive to the first and second audio signals are perceivably dimensionally separate from one another.

In further embodiments of the present invention, the first and second audio signals may be a single composite signal. The first and second audio signals may include respective first and second identification codes. The first and second audio signals may be identified in the composite signal based on the respective first and second identification codes. Furthermore, the first and second audio signals may be assigned to the first and second speaker channels using the first and second identification codes. In certain embodiments of the present invention, the first and second audio signals may be identified in the composite signal using a pattern recognition process. The first and second audio signals may be assigned to the first and second speaker channels based on results of the pattern recognition process. The pattern recognition process may include voice and/or non-voice pattern recognition.

In still further embodiments of the present invention, first and second video signals associated with the first and second audio signals, respectively, may be received at the communications device. The first and second video signals may be displayed at the communications device such that the first video signal is spatially associated with the first audio signal and the second video signal is spatially associated with the second audio signal. In certain embodiments of the present invention, first and second icons and/or pictures from a contact list of the communications device may be displayed. The first and second icons and/or pictures may be respectively associated with the first and second audio signals, such that the first and second icons and/or pictures are spatially associated with the first and second audio signals, respectively.

In some embodiments of the present invention, first and/or second images associated with the first and/or second audio signal, respectively, may be displayed at the communications device if the associated first and/or second speaker channel is active. The first audio signal may be assigned to the first speaker channel and the second audio signal may be assigned to the second speaker channel based on user preferences.

In further embodiments of the present invention, a third audio signal may be received at the communications device. The third audio signal may be assigned to a different third speaker channel of the device, such that sounds emanating from communications device responsive to the first, second and third audio signals are perceivably dimensionally separated from one another. The first speaker channel may be associated with a first speaker communicatively coupled to the communications device, the second speaker channel may be associated with a second speaker communicatively coupled to the communications device and the third speaker channel may be associated with the first speaker and the second speaker to output audio from both the first and second speakers.

Some embodiments of the present invention provide methods of processing signals received at a communications device. A composite audio signal including two or more separate audio signals is received at the communications device. The composite audio signals are separated into the two or more separate audio signals associated with respective two or more sources. The two or more audio signals are assigned to respective two or more different speaker channels, such that sounds emanating from the communications device responsive to the two or more audio signals are perceivably dimensionally separate from one another.

In further embodiments of the present invention, the two or more separate audio signals may include identification codes. The two or more audio signals in the composite signal may be identified based on the corresponding identification codes. The two or more audio signals may be assigned to the two or more speaker channels using the first and second identification codes.

In still further embodiments of the present invention, the two or more audio signals may be identified in the composite signal using a pattern recognition process. The two or more audio signals may be assigned to the first and second speaker channels based on results of the pattern recognition process. The pattern recognition process may include voice and/or non-voice pattern recognition.

While the present invention is described above primarily with reference to methods of operating communications devices, communications devices are also provided.

### BRIEF DESCRIPTION OF THE DRAWINGS

FIG. 1 is a schematic diagram of a mobile terminal according to some embodiments of the present invention and an exemplary base station transceiver.

FIGS. 2A and 2B are exemplary conferencing systems according to some embodiments of the present invention.

FIG. 3 is a flowchart illustrating operations of a communications device according to some embodiments of the present invention.

FIG. 4 is a flowchart illustrating operations of a communications device according to further embodiments of the present invention.

FIG. 5 is a flowchart illustrating operations of a communications device according to still further embodiments of the present invention

FIG. 6 is a flowchart illustrating operations of a communications device according to some embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items. As will be appreciated by one of skill in the art, the present invention may take the form of an entirely hardware embodiment, an entirely software embodiment or an embodiment combining software and hardware aspects all generally referred to herein as a “circuit” or “module.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

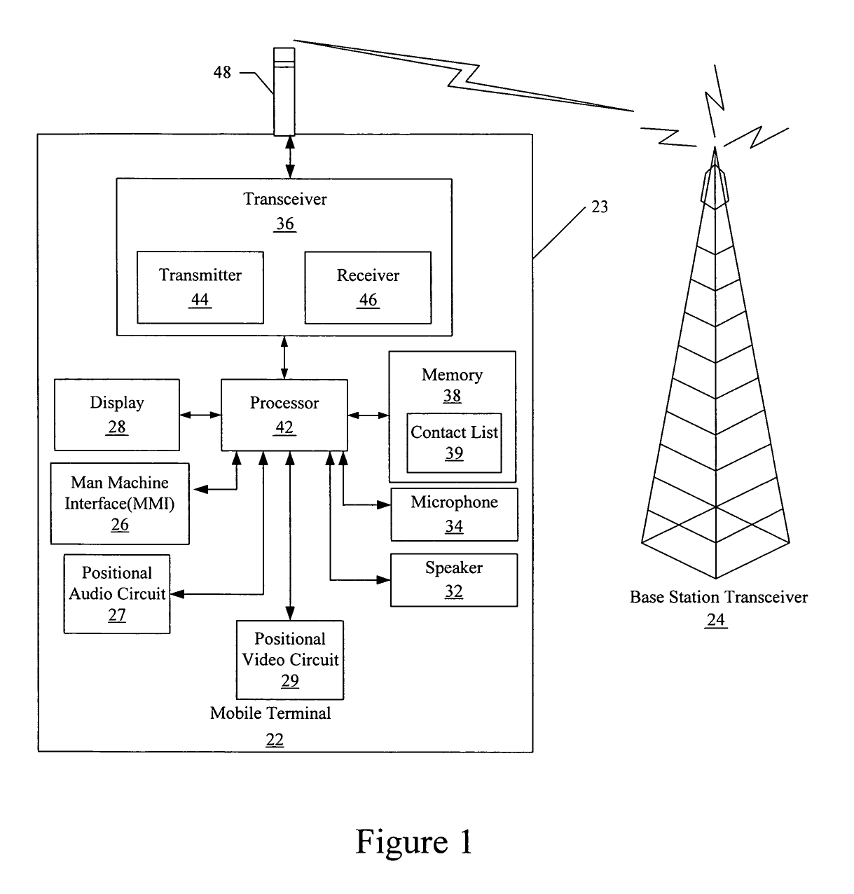

Embodiments of the present invention will now be described below with respect to FIGS. 1 through 6. Some embodiments of the present invention provide communications devices configured to receive conference calls including three or more parties, i.e., distinguishable audio signal sources. The communications devices may include positional audio circuits including, for example, digital signal processing (DSP) hardware and software, according to some embodiments of the present invention. The positional audio circuits may be configured to assign the incoming audio signals to separate speaker channels, such that the sounds emanating from the communications device responsive to the incoming audio signals are perceivably dimensionally separated. Separating the perceived output of the incoming audio signals of the receiving device may make it easier for a participant of the conference call to differentiate between the parties to the conference call and to hear what each of the parties is saying.

In certain embodiments of the present invention, the communications device may also include a positional video circuit configured to display an image associated with one or more of the parties to the conference call. These images may be displayed such that they are spatially associated with the associated audio signals. For example, if the sounds emanating from the communications device for a particular audio signal appear to be coming from the left, the image associated with this particular audio signal may be positioned on the left side of a display or on a left side of a plurality of displays. Accordingly, some embodiments of the present invention may provide conference capable communications devices having the ability to spatially distinguish sources of audio of the receiving device as discussed herein below.

As used herein, the term “communications device” or “mobile terminal” includes: a cellular radiotelephone with or without a multi-line display; a Personal Communications System (PCS) terminal that combines a cellular radiotelephone with data processing, facsimile and data communications capabilities; a Personal Data Assistant (PDA) that include a radiotelephone, pager, Internet/intranet access, Web browser, organizer, calendar and/or a global positioning system (GPS) receiver; a gaming device, an audio video player, and a conventional laptop and/or palmtop portable computer that include a radiotelephone transceiver.

The present invention is described below with reference to schematic and block diagrams of mobile terminals including positional audio and/or video circuits according to some embodiments of the present invention. Although positional audio and video circuits are discussed herein as being included as part of a mobile terminal, for example, mobile terminal 22 of FIG. 1, embodiments of the present invention are not limited to this configuration. Positional audio and video circuits according to embodiments of the present invention may be included in any wireless communications device configured to receive conference calls without departing from the scope of the present invention. Furthermore, although the present invention may be embodied in wireless communications devices or systems, such as the mobile terminal 22, the present invention is not limited to such devices and/or systems. Instead, the present invention may be embodied in any communication device that may be configured to receive conference calls.

Referring now to FIG. 1, a schematic block diagram is provided illustrating a wireless communications system in accordance with some embodiments of the present invention, which includes the mobile terminal 22 and a base station transceiver 24 of a wireless communications network. The mobile terminal 22 includes a portable housing 23 and may include a man machine interface (MMI) 26, for example, a keyboard, a display 28, a speaker 32, a microphone 34, a transceiver 36, and a memory 38 including a contact list 39, any of which may communicate with a processor 42. Furthermore, a mobile terminal 22 according to some embodiments of the present invention may further include a positional audio circuit 27 and/or a positional video circuit 29, which also communicate with the processor 42. The processor 42 can be any commercially available or custom microprocessor.

The transceiver 36 typically includes a transmitter circuit 44 and a receiver circuit 46, which respectively transmit outgoing radio frequency signals to the base station transceiver 24 and receive incoming radio frequency signals, such as voice and data signals, from the base station transceiver 24 via an antenna 48. The antenna 48 may be an embedded antenna, a retractable antenna or any antenna known to those having skill in the art without departing from the scope of the present invention. The radio frequency signals transmitted between the mobile terminal 22 and the base station transceiver 24 may include both traffic and control signals (e.g., paging signals/messages for incoming calls), which are used to establish and maintain communication with another party or destination. The processor 42 may support various functions of the mobile terminal 22, including functions related to the positional audio circuit 27 and the positional video circuit 29 of a mobile terminal 22 according to some embodiments of the present invention.

In some embodiments of the present invention, the base station transceiver 24 is a radio transceiver(s) that defines an individual cell in a cellular network and communicates with the mobile terminal 22 and other mobile terminals in the cell using a radio-link protocol. Although only a single base station transceiver 24 is shown, it will be understood that many base station transceivers may be connected through, for example, a mobile switching center and other devices, to define a wireless communications network.

Operations of a mobile terminal 22 according to some embodiments of the present invention will now be discussed with respect to FIG. 1. The receiver 46 may be configured to receive two or more audio signals at the mobile terminal 22. As discussed above, the mobile terminal 22 is configured to receive conference calls, i.e., calls involving three or more parties, the user of the mobile terminal 22 and at least two others. It will be understood that although embodiments of the present invention will be discussed herein with reference to three or four parties to the conference call to simplify the explanation, embodiments of the present invention are not limited to this configuration. Conference calls according to some embodiments of the present invention may include five or more parties without departing from the scope of the present invention. As used herein, a “party” is a distinguishable audio signal source.

Thus, for example, the receiver 46 may be configured to receive a first audio signal from a first remote communications device and a second audio signal from a second remote communications device. The first audio signal and the second audio signal received at the communications device may be distinct audio signals transmitted by a communications system on separate channels and separately received at the communications device. Alternatively, the first and second audio signals may both be combined and included in a composite audio signal generated by a service provider supporting a conference calling capability for the communications system that receives audio streams from two distinct sources and combines those streams into a composite signal to be received at the communication device. Such a combined signal may or may not include an identification of which components of the signal come from the respective distinct sources. In some embodiments of the present invention, identification information may be included for transmission along with the composite signal to allow the communications device to identify distinct first and second audio signals from the received composite signal. For example, the conference call may limit communications to allowing only a single source to be speaking at any point during the conference call and time segmentation in transmission of the composite signal may provide discrimination between the different sources. In such embodiments, therefore, the base station could allocate time displaced bursts of the composite audio signal to different sources. The allocation could be in a predetermined manner and the identification of the respective first and second audio signals for purposes of separate processing at the communications device may be provided by associating identification codes with the predetermined bursts to allow proper processing at the communications device. Alternatively, the segmentation can be in a non-predetermined fashion and additional control information could be provided, either in the communication burst or on a control channel associated with the voice communication, from the base station designating the source for the particular burst. In further alternative embodiments, the composite signal may include no ability to differentiate based on time receipt of a signal between different sources and voice pattern recognition may be used to separate out signals from the composite signals at the communications device. In such embodiments, where additional information about a respective source, beyond a voice pattern associated with the source, is known, such as a background noise environment in which the particular source is located, the pattern recognition information for the voice recognition process may further include background noise or other associated pattern recognition to further facilitate separating out and identifying each distinct audio signal source at the communications device. Identification of each source for proper processing at the communications device may be then based on the separated audio signal streams.

At the communications device, respective first and second speaker channels can be provided by utilization of distinct speakers. For example, various mobile terminal devices include both an earpiece speaker and an auxiliary speaker, typically used for higher volume, broader frequency range output, such as music, ring tones and the like. The first audio signal may be routed to the earpiece speaker and a second audio speaker may be routed to the auxiliary speaker. The respective speakers may be driven by distinct voice coder circuits within the communication device operating independently or a time sharing and switching arrangement may be utilized for driving both speakers with distinct signal streams utilizing a single voice coder circuit. In addition, an external speaker system may be provided and two distinct audio signal streams may be provided to respective distinct external speakers or a binaural or stereo signal may be provided where such a signal format is supported by the communications device and by the external speaker system coupled thereto. Similarly, where the voice signal is received in a packetized system such as Voice Over IP (VoIP), the packet addressing information may be used to identify distinct audio sources so as to allow separation of a first and second audio signal at the communication device.

Referring again to FIG. 1, the remote communications devices may be wireless communications devices or landline devices without departing from the scope of the present invention. The positional audio circuit 27 may be configured to assign the first audio signal to a first speaker channel of the speaker 32 and the second audio signal to a different, second speaker channel of the speaker 32. The speaker 32 may be one or more speakers.

In other words, the sounds emanating from the speaker 32 responsive to the first audio signal are perceivably dimensionally separated from the sounds emanating from the speaker 32 responsive to the second audio signal. As used herein, audio signals that are “dimensionally separated” refer to audio signals which are perceivable as emanating from different locations in a three dimensional space. For example, the audio signals may be assigned to different speaker channels to simulate different physical positions of the participants of the conference call. Thus, assigning the audio signals to different speaker channels may provide a “stereo” like result, where, for example, sounds from one source emanate from a left channel, sounds from a second source emanate from a center channel, and sounds from a third source emanate from a right channel. As such, it may be easier to hear the participants of the conference call as well as distinguish between participants.

In some embodiments of the present invention, an external device, for example, a set of headphones or a separate speaker or speakers may be configured to plug into the mobile terminal 22. For example, if the mobile terminal 22 is plugged into a set of headphones, the first audio signal may be assigned to a first ear speaker and the second audio signal may be assigned to a second ear speaker.

It will be understood that there are many methods that may be used to assign specific audio signals to specific speaker channels. For example, the positional audio circuit 27 may have default configurations set therein, where, for example, a first signal received is assigned to a first speaker channel, a second signal received is assigned to a second speaker channel and so on. Furthermore, the positional audio circuit 27 may be configured to assign channels from left to right. In some embodiments of the present invention, the user may customize which channels should be allocated to which audio signals. For example, the user may listen to the received audio signals and select the positions for each audio signal based on where the user perceives the sounds to be emanating from at the mobile terminal 22. These embodiments are provided for exemplary purposes only and, thus, embodiments of the present invention are not limited to this configuration.

Although the positional audio circuit 27 is illustrated in FIG. 1 as being included in the mobile terminal 22, embodiments of the present invention are not limited to this configuration. For example, the positional audio circuit 27 may be part of the base station 24 without departing from the scope of the present invention.

Stereo or multichannel transmission may be possible using, for example, “Push to Talk over Cellular” (POC). Packet-switched data or PoC within GSM as mentioned above may solve the problem of sending and receiving addresses. In other words, identifying the audio channel uniquely and being able to keep track of them independent of the connection may no longer be a concern as discussed in Real-Time Transport Protocol (RTP) Payload Format and File Storage Format for the Adaptive Multi-Rate (AMR) and Adaptive Multi-Rate Wideband (AMR-WB) Audio Codecs, the disclosure of which is incorporated herein as if set forth in its entirety.

The incoming first and second audio signals may be identified using many techniques so that the audio signals may be directed to the correct speaker channel of the mobile terminal 22. For example, the positional audio circuit 27 may be configured to detect an identification code or tag included with the first and second audio signals. This identification code or tag may be included with each transmission to indicate to which of the speaker channels the audio signal it should be allocated. Thus, the positional audio circuit 27 may be configured to assign the first and second audio signals to the first and second speaker channels using first and second identification codes, addresses or tags.

In some embodiments of the present invention, identification codes may not be assigned. For example, the positional audio circuit 27 may be configured to identify the first and second audio signals using a voice recognition process. In particular, the first audio signal received from the first remote device may be analyzed, a first pattern may be recognized in the audio signal received and the first audio signal having the first pattern may be assigned to the first speaker channel. Thus, each time the mobile terminal 22 receives an audio signal having the first pattern it may be assigned to the first speaker channel. Similarly, a second pattern may be recognized and assigned to the second audio signal. Thus, the positional audio circuit 27 may use the results of the voice pattern recognition process to assign the first and second audio signals to the first and second speaker channels. In some embodiments of the present invention, only one of the audio signals, assuming there are only two incoming audio signals, may be patterned and assigned to the first speaker channel. Thus, in these embodiments, when an audio signal is received at the mobile terminal 22 that does not match the identified pattern, this audio signal may be assigned to the second speaker channel as a default. It will be understood that this technique may be used in conference calls having more than two incoming audio signals. However, in some embodiments of the present invention having more than two incoming audio signals, all but one of the incoming audio signals may be patterned such that only one unpatterned audio signal remains for default assignment.

In some embodiments of the present invention, the background noise, environment or other recognizable/detectable information associated the audio signals may be used to further distinguish between the audio signals rather than just the speakers voice pattern.

In some embodiments of the present invention, the mobile terminal 22 may further include a positional video circuit 29 as illustrated in FIG. 1. The positional video circuit 29 may be configured to provide, for example, on the display 28, an image associated with each of the incoming audio signals. These images may be positioned on the display 28 such that they appear to be spatially associated with their corresponding audio signal. As used herein, an image is “spatially associated” with its corresponding audio signal when the image is substantially positioned where it would appear that the party's voice would be coming from, if present. For example, an image associated with the audio signal assigned to the left channel of a speaker may be positioned on the left side of the display 28. Furthermore, the positional video circuit 29 may be further configured to display only the images associated with the active audio signals, i.e., only display images associated with participants of the conference call that are currently talking. It will be understood that the images may be displayed on more than one display, which may be spatially displaced.

In some embodiments of the present invention, the receiver is configured to receive the images, for example, video signals, associated with the audio signals. The positional video circuit 29 may be configured to display the video signals such that the first video signal is spatially associated with the first audio signal on the display 28, the second video signal is spatially associated with the second audio signal on the display 28 and so on. It will be understood that a mobile terminal 22 according to some embodiments of the present invention that receive video signals may be configured to be attached to a packet network, for example, the General Packet Radio Service (GPRS) of the Global System for Mobile Communications (GSM) network. In further embodiments of the present invention, the audio signals may be provided using VoIP.

In some embodiments of the present invention, the images may be icons associated with the audio signals. For example, the positional video circuit 29 may be configured to obtain first and second icons and/or pictures from a contact list 39 of the mobile terminal 22. The first icon may be associated with a user of the originating device of the first audio signal and the second icon may be associated with a user of the originating device of the second audio signal. The first and second icons and/or pictures may be provided on the display 28 such that the first and second icons and/or pictures are spatially associated with the first and second audio signals, respectively. Although the positional video circuit 29 is illustrated in FIG. 1 as being included in the mobile terminal 22, embodiments of the present invention are not limited to this configuration. For example, the positional video circuit 29 may be included in the base station 24 without departing from the scope of the present invention. In some embodiments of the present invention, the base station may deliver the images using, for example, General Packet Radio Service (GPRS).

It will be understood that in embodiments of the present invention obtaining icons/pictures from a contact list 39, the mobile terminal may associate a source of the audio signal with an entry in the contact list 39. For example, when the mobile terminal 22 receives the first audio signal from a first source, for example, a second mobile terminal, a caller identification function may identify who or what the first source is by, for example, an originating telephone number. The identified originating telephone number of the second mobile terminal may then be used to access a record or entry in the contact list 39 of the receiving mobile terminal 22. The accessed record may or may not include an image (icon/picture) that may be displayed at the mobile terminal 22.

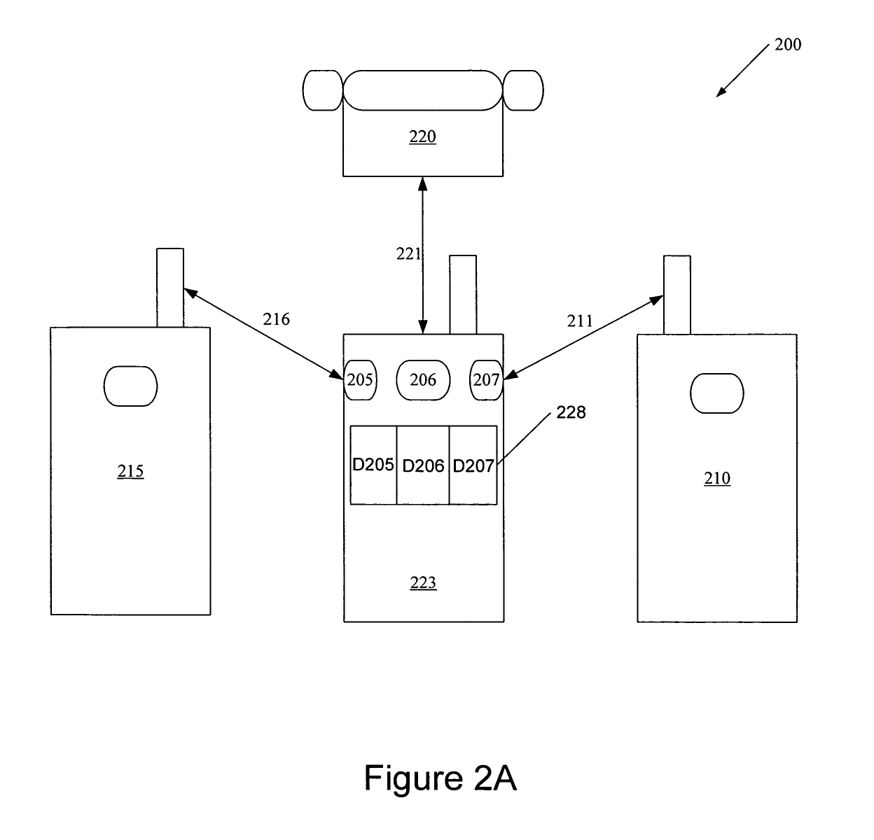

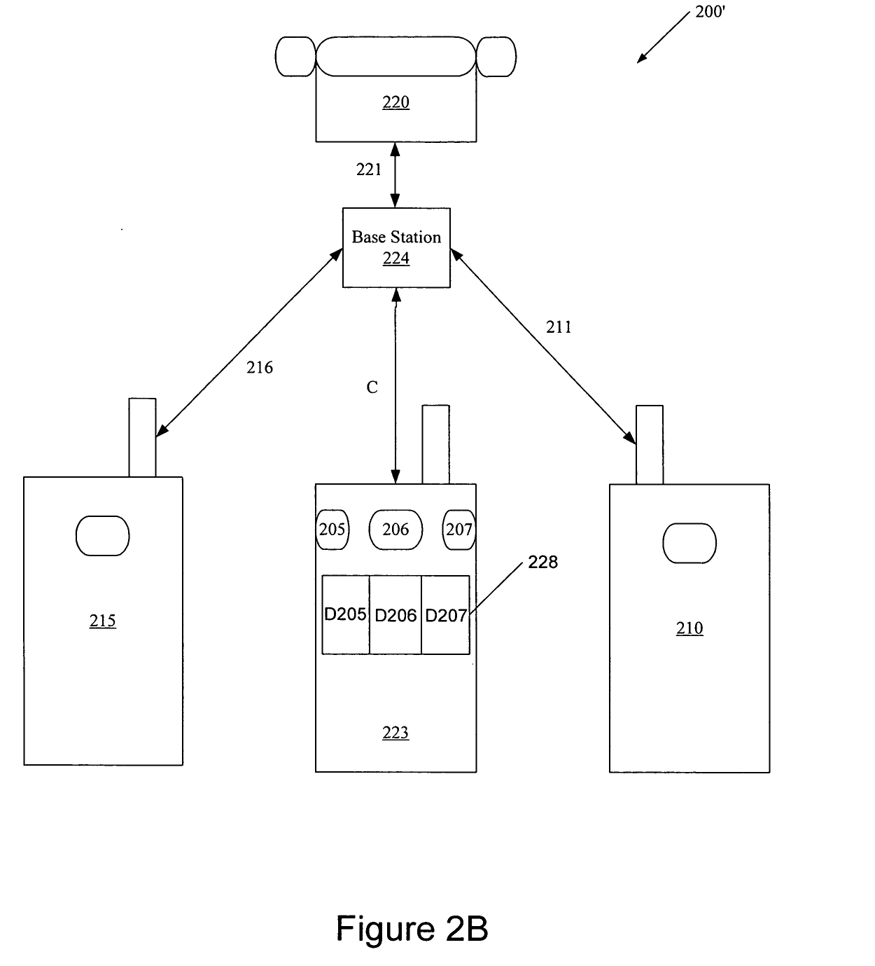

Referring now to FIGS. 2A and 2B, exemplary operations of the conference call system 200 (200′) according to some embodiments of the present invention will be discussed. It will be understood that the systems 200 and 200′ are provided to facilitate discussions with respect to exemplary operations of communications devices according to embodiments of the present invention and, therefore, do not illustrate a complete system. For example, although the audio signals are illustrated as being transmitted directly to the speakers in FIG. 2A, those having skill in the art understand that there is further processing involved between receipt of the audio signal and provision to the speakers.

As illustrated in FIGS. 2A and 2B, the system 200 (200′) includes a wireless communications device 223. The wireless communications device may include the positional audio circuit 27 and the positional video circuit 29 according to some embodiments of the present invention discussed above with respect to FIG. 1. As further illustrated in FIGS. 2A and 2B, the wireless communications device 223 includes first, second and third speakers 205, 206 and 207, respectively, and a display 228. The wireless communications device 223 receives first 211, second 216 and third 221 audio signals from first, second and third remote devices 210, 215 and 220, respectively. Although embodiments of the present invention illustrated in FIGS. 2A and 2B show the first and seconds remote devices 210 and 215 being wireless communications devices and the third remote device 220 being a landline device, embodiments of the present invention are not limited to this configuration. Furthermore, the conference call is not limited to four participants, the conference call may include three or more than five participants without departing from the scope of the present invention. Furthermore, a communication link from a single device may carry more than one audio signal 211, 216 and 221. For example, two participants may be sharing a remote device 210, 215 and 220.

In operation, the wireless communications device 223 receives first 211, second 216 and third 221 audio signals from the first 210, second 215 and third 220 remote devices, respectively. As discussed above, the first 211, second 216 and third 221 audio signals received at the wireless communications device 223 may be distinct audio signals transmitted by first 210, second 215 and third 220 remote devices and separately received at the communications device as illustrated in FIG. 2A. Alternatively, the first 211, second 216 and third 221 audio signals may be combined and included in a composite audio signal C generated by a service provider (base station 224) supporting a conference calling capability for the communications system that receives first 211, second 216 and third 221 audio signals from the first 210, second 215 and third 220 remote devices and combines those audio signals into a composite signal C to be received at the wireless communication device 223.

The positional audio circuit of the wireless communications device 223 may assign the first audio signal to a first channel output by the first speaker 205, the second audio signal to a second channel output by the second speaker 206 and the third audio signal to a third channel output by the third speaker 207. Thus, each of the audio signals may emanate from different speakers. In some embodiments of the present invention, a fourth channel may be provided, the fourth channel may be provided by allowing a portion of a fourth audio signal to emanate from two speakers to create the fourth channel. For example, a portion of the fourth audio signal may emanate from the first speaker 205 and a portion of the fourth audio signal may emanate from the second speaker 206. Similarly known stereo techniques for playing music may be used to position a plurality of sources in different locations substantially independent of the number of speakers available so long as at least two spatially displaced speakers are provided. For example, the wireless communications device 223 may be configured to electrically couple a stereo system in an automobile. Some modern automobiles have up to six speakers, therefore, allowing separation of the incoming audio signals among these speakers.

The wireless communications device 223 of FIGS. 2A and 2B may also include a positional video circuit as discussed above with respect to FIG. 1. In particular, the first D205, second D206 and third D207 images may be provided on the display 228 and may correspond to the first 211, second 216 and third 221 audio signals, respectively. As discussed above, these images may be video data streams received from the remote devices or icons/pictures stored, for example, in the contact list of the wireless communications device 223.

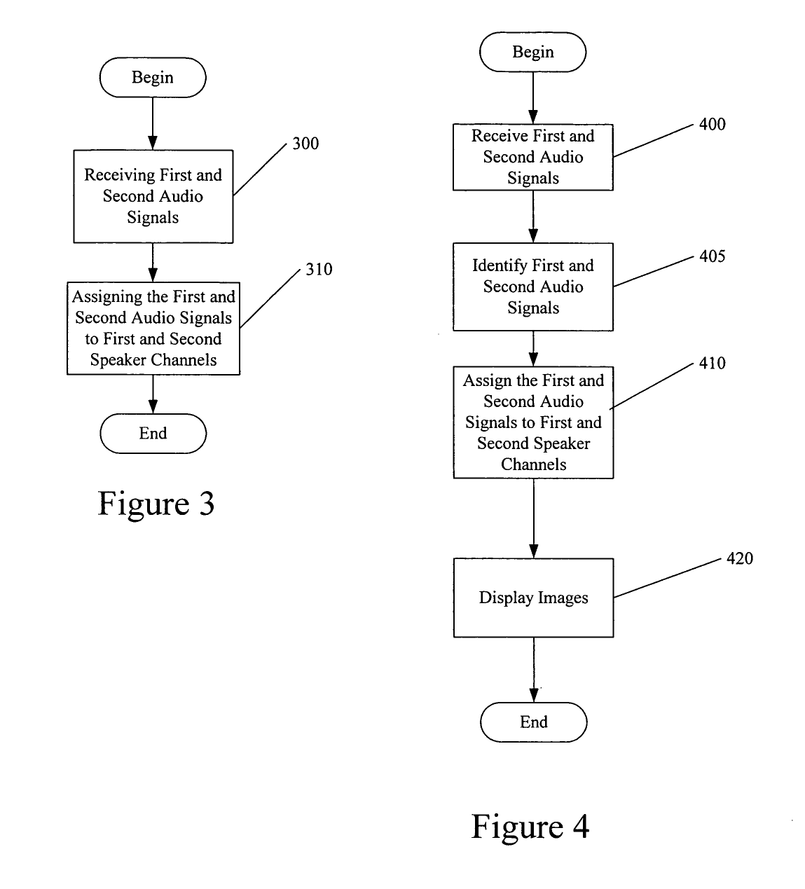

Referring now to FIGS. 3 through 6, operations of communications devices according to some embodiments of the present invention for processing signals received at the communications device will be discussed. Referring first to FIG. 3, operations begin at block 300 by receiving first and second audio signals at a communications device. The first audio signal is assigned to a first speaker channel and the second audio signal is assigned to a different second speaker channel (block 310). Assigning the first and second audio signals to first and second distinct speaker channels may allow the sounds emanating from communications device responsive to the first and second audio signals to be dimensionally separate from one another. Thus, the audio signals may be more understandable and more easily distinguishable. As discussed above, the base station may support stereo transmission using PoC.

Referring now to FIG. 4, operations for the illustrated embodiments begin at block 400 by receiving a first and second audio signal at a communications device. The first and second audio signals may be identified at the communications device or the base station (block 405). In some embodiments of the present invention, the first and second audio signals may be identified by respective first and second identification codes or tags. In further embodiments of the present invention, the first and second audio signals may be identified using a voice recognition process. In some embodiments of the present invention using voice recognition, background noise patterns may be used in addition to voice recognition to further distinguish the first audio signal from the second audio signal.

The identification codes or the identified voice patterns may be used to assign to first and second speaker channels (block 410) as discussed above. Images may be provided on a display at the communications device that correspond to the first and second audio signals (block 420). For example, if the first audio signal is assigned to a left speaker channel, an image associated with first audio signal may be displayed on the left side of the display. Similarly, if the second audio signal is assigned to a right speaker channel, an image associated with the second audio signal may be displayed on the right side of the display. In some embodiments of the present invention, the images may be stored in a contact list at the communications device. For example, an icon or picture associated with a user of the first audio signal may be stored in the contact list and may be displayed on the display in a way that is spatially associated with the first audio signal or may be displayed when the first audio signal is active.

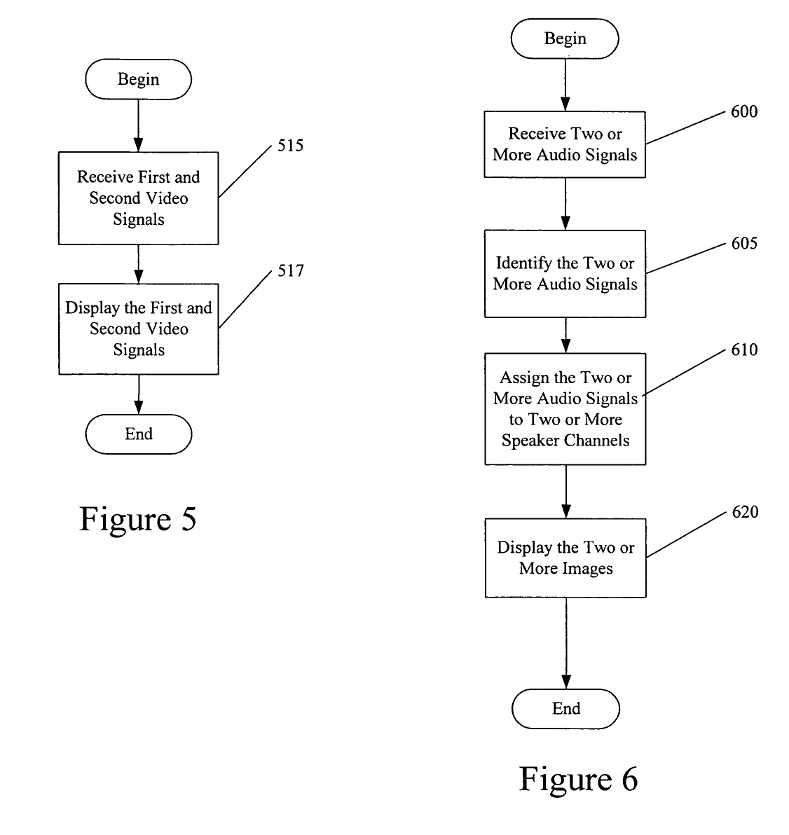

Referring now to FIG. 5, methods of displaying images according to some embodiments of the present invention will be further discussed. Operations begin at block 515 by receiving first and second video signals associated with the first and second audio signals, respectively, at the communications device. The first and second video signals may be static or dynamic without departing from the scope of the present invention. In the embodiments of the present invention illustrated in FIG. 5, the communications device may be configured to receive data packets and the received images may be received as, for example, GPRS packets. The first and second video signals may be displayed at the communications device such that the first video signal is spatially associated with the first audio signal and the second video signal is spatially associated with the second audio signal (block 517).

Referring now to FIG. 6, operations according to some embodiments of the present invention begin at block 600 by receiving two or more audio signals at a communications device. The two or more audio signals may be identified at the communications device or the base station (block 605). The two or more signals may be assigned to two or more respective speaker channels using the identification codes or the identified voice patterns (block 610). Images may be provided on a display at the communications device that are spatially associated with the two or more audio signals (block 420).

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method of processing signals received at a communications device, comprising:
receiving a first audio signal from a first source at the communications device;
receiving a second audio signal from a second source at the communications device; and
assigning the first audio signal to a first speaker channel and the second audio signal to a second speaker channel, different from the first speaker channel, such that sounds emanating from the communications device responsive to the first and second audio signals are perceivably dimensionally separate from one another.

2. The method of claim 1, wherein receiving the first and second audio signals comprises receiving the first and second audio signals as a single composite signal at the communications device and wherein the first and second audio signals comprise respective first and second identification codes, the method further comprising:
identifying the first and second audio signals in the composite signal based on the respective first and second identification codes and wherein assigning further comprises assigning the first and second audio signals to the first and second speaker channels using the first and second identification codes.

3. The method of claim 1, wherein receiving the first and second audio signals further comprises receiving the first and second audio signals as a single composite signal at the communications device, the method further comprising:
identifying the first and second audio signals in the composite signal using a pattern recognition process and wherein assigning further comprises assigning the first and second audio signals to the first and second speaker channels based on results of the pattern recognition process.

4. The method of claim 3, wherein the pattern recognition process comprises a voice pattern recognition process.

5. The method of claim 4, wherein the pattern recognition process further comprises non-voice pattern recognition.

6. The method of claim 1, further comprising:
receiving first and second video signals associated with the first and second audio signals, respectively, at the communications device; and
displaying the first and second video signals at the communications device such that the first video signal is spatially associated with the first audio signal and the second video signal is spatially associated with the second audio signal.

7. The method of claim 1, further comprising displaying first and second icons and/or pictures from a contact list of the communications device, the first and second icons and/or pictures being respectively associated with the first and second audio signals, such that the first and second icons and/or pictures are spatially associated with the first and second audio signals, respectively.

8. The method of claim 1, further comprising visually displaying a first and/or second image associated with the first and/or second audio signal, respectively, at the communications device if the associated first and/or second speaker channel is active.

9. The method of claim 1, wherein assigning comprises assigning the first audio signal to the first speaker channel and the second audio signal to the second speaker channel based on user preferences.

10. The method of claim 1, further comprising:
receiving a third audio signal at the communications device; and
assigning the third audio signal to a third speaker channel of the wireless electronic device, the third speaker channel being different from the first and second speaker channels, such that sounds emanating from communications device responsive to the first, second and third audio signals are perceivably dimensionally separated from one another.

11. The method of claim 10, wherein the first speaker channel is associated with a first speaker communicatively coupled to the communications device, wherein the second speaker channel is associated with a second speaker communicatively coupled to the communications device and wherein the third speaker channel is associated with the first speaker and the second speaker to output audio from both the first and second speakers.

12. A method of processing signals received at a communications device, comprising:
receiving first and second audio signals from respective first and second sources at the communications device;
assigning the first audio signal to a first speaker channel and the second audio signal to a second speaker channel, different from the first speaker channel, such that sounds emanating from the communications device associated with the first and second audio signals are perceivably dimensionally separated from one another; and
displaying first and/or second images respectively associated with the first and second audio signals such that the first and second images are spatially associated with the first and second audio signals, respectively.

13. The method of claim 12, wherein displaying first and second images further comprises:
receiving first and second video signals associated with the first and second audio signals, respectively, at the communications device; and
displaying the first and second video signals at the communications device such that the first video signal is spatially associated with the first audio signal and the second video signal is spatially associated with the second audio signal.

14. The method of claim 12, wherein displaying further comprises displaying first and second icons and/or pictures from a contact list of the communications device, the first and second icons and/or pictures being respectively associated with the first and second audio signals, such that the first and second icons and/or pictures are spatially associated with the first and second audio signals, respectively.

15. The method of claim 12, wherein displaying the first and/or second image comprises displaying the first and/or second image if the associated first and/or second speaker channel is active.

16. A method of processing signals received at a communications device, comprising:
receiving a composite audio signal including two or more separate audio signals at the communications device;
separating the composite audio signal into the two or more separate audio signals associated with respective two or more sources; and
assigning the two or more audio signals to respective two or more different speaker channels, such that sounds emanating from the communications device responsive to the two or more audio signals are perceivably dimensionally separate from one another.

17. The method of claim 16, wherein the two or more separate audio signals comprise corresponding identification codes, the method further comprising:
identifying the two or more audio signals in the composite signal based on the corresponding identification codes and wherein assigning further comprises assigning the two or more audio signals to the two or more speaker channels using the first and second identification codes.

18. The method of claim 16, further comprising identifying the two or more audio signals in the composite signal using a pattern recognition process and wherein assigning further comprises assigning the two or more audio signals to the first and second speaker channels based on results of the pattern recognition process.

19. The method of claim 18, wherein the pattern comprises voice and/or non-voice pattern recognition.

20. A communications device, comprising:
a receiver configured to receive a first audio signal from a first source at the communications device and a second audio signal from a second source at the communications device; and
a positional audio circuit configured to assign the first audio signal to a first speaker channel and the second audio signal to a second speaker channel, different from the first speaker channel, such that sounds emanating from the communications device responsive to the first and second audio signals are perceivably dimensionally separate from one another.

21. The communications device of claim 20, wherein the receiver is further configured to receive the first and second audio as a single composite signal, wherein the first and second audio signals comprise respective first and second identification codes, wherein the positional audio circuit is further configured to identify the first and second audio signals in the composite signal based on the respective first and second identification codes and assign the first and second audio signals to the first and second speaker channels using the first and second identification codes.

22. The communications device of claim 20, wherein the receiver is further configured to receive the first and second audio signals as a single composite signal and wherein the positional audio circuit is further configured to identify the first and second audio signals in the composite signal using a pattern recognition process assign the first and second audio signals to the first and second speaker channels based on results of the pattern recognition process.

23. The communications device of claim 22, wherein the pattern recognition process comprises voice and/or non-voice pattern recognition.

24. The communications device of claim 20, wherein the receiver is further configured to receive first and second video signals associated with the first and second audio signals, respectively, at the communications device, the device further comprising:
a display; and
a positional video circuit configured to provide the first and second video signals on the display at the communications device such that the first video signal is spatially associated with the first audio signal and the second video signal is spatially associated with the second audio signal.

25. The communications device of claim 20, further comprising:
a display; and
a positional video circuit configured to provide first and second icons and/or pictures from a contact list of the communications device on a display of the communications device, the first and second icons and/or pictures being respectively associated with the first and second audio signals, such that the first and second icons and/or pictures are spatially associated with the first and second audio signals, respectively.

26. The communications device of claim 20, wherein the positional video circuit is further configured to assign the first audio signal to the first speaker channel and the second audio signal to the second speaker channel based on user preferences.

27. The communications device of claim 20 wherein the receiver is further configured to receive a third audio signal at the communications device and wherein the positional video circuit is further configured to assign the third audio signal to a third speaker channel of the communications device, the third speaker channel being different from the first and second speaker channels, such that sounds emanating from communications device responsive to the first, second and third audio signals are perceivably dimensionally separate from one another.

28. The communications device of claim 27, wherein the first speaker channel is associated with a first speaker communicatively coupled to the communications device, wherein the second speaker channel is associated with a second speaker communicatively coupled to the communications device and wherein the third speaker channel is associated with the first speaker and the second speaker to output audio from both the first and second speakers.

29. The communications device of claim 20, wherein the communications device comprises a wireless communications device and/or a portable communications device.
